(19) United States
(12) Patent Application Publication
(10) Pub. No.: US 2026/0210812 A1
(43) Pub. Date: Jul. 23, 2026

(54) A VOLATILE SUBSTANCE SAMPLING DEVICE

(71) Applicant: Foster & Freeman Limited, Evesham (GB)

(72) Inventors: Cameron Heaton, Alcester (GB); Simon Clement, Evesham (GB); Roberto King, Evesham (GB); Jim Reynolds, Loughborough (GB); Paul Kelly, Loughborough (GB)

(73) Assignee: Foster & Freeman Limited, Evesham, EN (GB)

(21) Appl. No.: 19/144,388

(22) PCT Filed: Feb. 8, 2024
(86) PCT No.: PCT/GB2024/050348

§ 371 Date: Jun. 27, 2025

(30) Foreign Application Priority Data
Feb. 8, 2023 (GB) 2301789.0

(51) Int. Cl. G01N 1/22; G01N 1/44; G01N 27/622

(52) U.S. Cl. CPC G01N 1/22; G01N 1/44; G01N 27/622

(57) ABSTRACT

The present invention relates to a device and methods for the analysis of volatile organic compounds and particularly, but not exclusively, a device comprising a probe for collection of volatile organic compounds coupled with a spectrometer.

### FIELD OF THE INVENTION

This invention relates to a device and methods for the analysis of volatile organic compounds and particularly, but not exclusively, a device comprising a probe for collection of volatile organic compounds coupled with a spectrometer.

### BACKGROUND TO THE INVENTION

Suspected biofluid evidence is generally subjected to rapid, colorimetric testing in situ at the crime scene, to yield a presumptive identification. These chemical tests are susceptible to false positives (indicating a substance is present when it isn't) and false negatives (indicating a substance is not present when it is), depending on the chemical interactions of the specific test employed. Human biofluids (blood (peripheral and menstrual), semen, saliva, urine, sweat, and vaginal fluid) all require a different chemical test. These reagents may dilute or consume the sample, affecting further analysis, and some of the chemicals used may be harmful to users. They also may require specific lighting conditions and be time consuming processes.

Without definitive identification at the crime scene, sometimes ‘irrelevant’ samples are also recovered, consuming resources in terms of time, and single-use evidence bags/containers. Recovered samples (both ‘relevant’ and ‘irrelevant’) generally then undergo further confirmatory analysis, which are usually complex, expensive, and time-consuming analytical processes. The analysis of the ‘irrelevant’ samples is wasteful in terms of resources (single-use materials, reagents etc.) and energy. A more reliable method of initial identification would allow more rapid and effective triaging of suspected evidence at the crime scene, minimizing the volume of ‘irrelevant’ samples requiring recovery and subsequent confirmatory analysis and the associated wastage.

An alternative solution would be to perform an initial analysis on items of interest in-situ, or in order to identify the part of the item of interest to focus on (for example if the item is large but the area of interest is relatively small).

Additionally, it is advantageous to have a method of analysis which is minimally destructive, such that further analysis may be performed if necessary, and where there is the ability to perform such analysis outside of a laboratory environment.

Using traditional methods, the sample must be taken from a crime scene to a laboratory. The first step is then to examine the sample to identify one or more areas of interest (areas which are potentially contaminated with human biofluids), and to record in detail the location of area of interest on the sample. This is followed by a second step employing a method of confirmatory chemical analysis on the one or more areas of interest, to ascertain the identity of the contaminant on the area of interest.

Rankin-Turner S et al., Chem. Sci., 2019, 10, 1064-1069 (doi: 10.1039/C8SC04133D), describes a rapid, in-situ identification device for use examining human body fluids, using mass spectrometry. This showed the possibility of the use of such a sampling device to obtain information on various samples. However, the disclosed device is not suitable for use in the field as the instrumentation was bulky, operated under vacuum and required a fixed gas line.

By using wavelengths which target the absorption bands of specific substances, the target substance can be preferentially heated to generate volatiles more effectively from that substance. This also minimises the production of volatiles from contaminants in the localised area that do not share the same absorption band.

The present invention seeks to overcome at least one of the prior art disadvantages.

### SUMMARY OF THE INVENTION

According to first aspect of the present invention there is provided a gas sampling device comprising:
(i) a first pump;
(ii) a second pump;
(iii) a heater;
(iv) a first transfer line wherein the first transfer line comprises a first end and a second end;
(v) a second transfer line wherein the second transfer line comprises a first end and a second end;
(vi) at least one heating light source;
(vii) an optical transfer line; and
(viii) at least one illuminating light source;
wherein the heater is configured to transfer heat to the first transfer line;
wherein a portion of the second transfer line defines a common transfer line portion;
wherein the optical transfer line and the common transfer line portion are configured to transfer light from the heating light source to the first end of the second transfer line;
wherein the first pump is configured to move a first gas via the first end of the first transfer line to the second end of the first transfer line; and
wherein the second pump is configured to move a second gas via the first end of the second transfer line to the second end of the second transfer line.

With the common transfer line portion and the optical transfer line configured to transfer light from the heating light portion to the first end of the second transfer line, this provides for a significant advantage in terms of targeted heating of a sample. In-use, heated gas (e.g. air) from the first transfer line provides for a general heating. With the device positioned adjacent (pointing at) a sample surface, heating light exiting the first end of the second transfer line is directed at the sample surface and volatilises materials (e.g. volatile organics in blood spatter). The volatilised organics can then be directly drawn into the first end of the second transfer line and transferred to an analysis device (e.g. an ion mobility spectrometer (IMS)).

This direct heating using heating light provides for highly targeted volatilisation of materials. As detailed below, the heating light can be specific to a particular type of biofluid which is being tested for, e.g. blood (peripheral or menstrual), semen, saliva, urine, sweat or vaginal fluid.

In certain embodiments, the device additionally comprises a visible marker light source. This is configured such that a visible marker is in-use propagated from the first end of the second transfer line. Thus, in-use a visible marker is provided showing exactly where the heating light is targeted. In certain embodiments, the visible marker light source is the in the form of a red, green, or blue light source. In certain embodiments, the visible marker light source is in the form of an LED. In certain embodiments, the visible marker light source is in the form of a red LED. In certain embodiments, the device is configured to transfer output light from the visible marker light source to the first end of the second transfer line. In certain embodiments, the device is configured to transfer output light from the visible marker light source via the common transfer line portion of the second transfer line to the first end of the second transfer line. In certain embodiments, the device is configured to transfer output light from the visible marker light source via the optical transfer line and the common transfer line portion to the first end of the second transfer line. In other embodiments, the device additionally comprises a second optical transfer line and the device is configured to transfer output light from the visible marker light source via the second optical transfer line and the common transfer line portion to the first end of the second transfer line. Output light from the visible marker light source can then in-use propagate from the first end of the second transfer line.

As noted above, the ability to preferentially volatise compounds of interest while not volatising the sample matrix or components of the substrate material is advantageous. Thus, the quantity of volatilised contaminants (i.e. volatiles from non-target locations on a sample) can be reduced. By having heating light emitted from the first end of the second transfer line, the capture of volatilised materials is also improved, increasing the sensitivity achieved with attached analysis devices. The use of a heating light can also increase the energy efficiency achieved by the device. This is particularly useful for battery-powered (e.g. hand-held) devices.

Pumps include gas flow generators. Suitable pumps include piezoelectric pumps. Examples of pumps include disc pumps. In certain embodiments, the first pump is a disc pump. In certain embodiments, the second pump is a disc pump. In certain embodiments, the first and second pumps are disc pumps. Disc pumps include those described in U.S. Pat. No. 8,821,134, WO2004090335, WO2006111775, WO2009112866, WO2010139917, WO2011097361, WO2011097362, WO2011146535, WO2013043300, WO2013119860, WO2013134056, WO2013119837, WO2013119854, WO2013130255, WO2013158659, WO2013158897, WO2014008348, and WO2014008354.

The first and second pumps are configured to in-use move gas. In certain embodiments, the first pump is configured to draw the first gas via the first end of the first transfer line to the second end of the first transfer line. In certain embodiments, the second pump is configured to draw the second gas draw via the first end of the second transfer line to the second end of the second transfer line.

In certain embodiments, the first transfer line comprises one or more of metal and plastic. In certain embodiments, the first transfer line comprises metal. In certain embodiments, the first transfer line comprises plastic. In certain embodiments, the first transfer line comprises nylon or polytetrafluoroethylene. In certain embodiments, the first transfer line comprises nylon. In certain embodiments, the transfer line comprises polytetrafluoroethylene. In certain embodiments, the first transfer line comprises metal and plastic. In certain embodiments, the first transfer line comprises stainless steel. In certain embodiments, the first transfer line comprises a heat resistant material. In certain embodiments, the first transfer line comprises a material which is resistant to deformation at temperatures in the range of 50 Deg C. (° C.) to 130 Deg C. (° C.).

In certain embodiments, the second transfer line comprises one or more of metal and plastic. In certain embodiments, the second transfer line comprises metal. In certain embodiments, the second transfer line comprises plastic. In certain embodiments, the second transfer line comprises metal and plastic. In certain embodiments, the second transfer line comprises stainless steel. In certain embodiments, the second transfer line comprises a heat resistant material. In certain embodiments, the second transfer line comprises a material which is resistant to deformation at temperatures in the range of 50 Deg C. to 130 Deg C.

The optical transfer line is configured to transfer light from the at least one heating light source. In certain embodiments, the optical transfer line comprises an optical fibre.

In certain embodiments, the optical transfer line is configured to transfer light from the heating light source to the common transfer line portion, and the common transfer line portion of the second transfer line is configured to transfer the light to the first end of the second transfer line.

In certain embodiments, the optical transfer line comprises a reflective inner surface. In certain embodiments, the optical transfer line comprises an inner surface reflective to the one or more wavelengths of the heating light source. In certain embodiments, the common transfer line portion comprises a reflective inner surface. In certain embodiments, the common transfer line portion comprises an inner surface reflective to the one or more wavelengths of the heating light source. In certain embodiments, the optical transfer line and the common transfer line portion comprise a reflective inner surface.

In certain embodiments, the optical transfer line and the second transfer line together define a substantially T- or Y-shaped arrangement. In this arrangement, one arm of the T or Y shaped transfer line is the common transfer line portion, with one arm being a light carrying part, and one arm being a gas carrying part.

Thus, the optical transfer line and the common transfer line portion (of the second transfer line) are configured to transfer light from the heating light source to the first end of the second transfer line. Thus, light from the heating light source is in-use transferred via the optical transfer line to the second transfer line, along which it propagates to the first end of the second transfer line and to a sample surface which is being tested. This allows for enhanced (targeted) heating of a sample (e.g. a biofluid sample) on a sample surface, enhancing desorption of volatiles from the targeted portion of the sample surface.

The use of a heating light can also improve the energy efficiency of the device, which is a desirable environmental improvement. In the case of a hand-held (e.g. battery powered) device, the improvement in energy efficiency can help extend battery life.

In certain embodiments, the at least one illuminating light source is selected from a lamp or a light emitting diode. In preferred embodiments, the at least one illuminating light source is at least one light emitting diode. In certain embodiments, the at least one illuminating light source is selected independently.

In certain embodiments, the device additionally comprises a camera.

In certain embodiments, the camera is a complementary metal oxide semiconductor (CMOS) camera. In certain embodiments, the camera is capable of multispectral imaging. In certain embodiments the camera is configured to capture images in the ultraviolet spectrum. In certain embodiments the camera is configured to capture images in the infrared spectrum. In certain embodiments the camera is configured to capture images in the visible spectrum. In certain embodiments the camera is configured to capture images in the infrared, ultraviolet and visible spectrum.

In certain embodiments, the camera has a range of detection wavelengths of between 250 nm and 1000 nm. In certain embodiments, the camera has a discrete detection wavelength between 250 nm and 1000 nm. In certain embodiments, the camera has a range of detection wavelengths between 400 nm and 450 nm. In certain embodiments a filter is used in the camera. In certain embodiments, the filter blocks ultraviolet light. In certain embodiments, the filter blocks near-infrared light. In certain embodiments, the filter blocks both ultraviolet light and near-infrared light.

In certain embodiments, the heating light source has a wavelength of one or more of near ultraviolet, violet and infrared. In certain embodiments, the heating light source has a wavelength of one or more of 350-400 nm, 400-420 nm and >700 nm. In certain embodiments, the heating light source has a wavelength of one or more wavelengths within the range 350-400 nm, 400-420 nm and greater than 700 nm. In preferred embodiments, the heating light source correlates with the absorption bands of common biofluids. In preferred embodiments, the heating light source correlates with the absorption bands of one or more of blood (peripheral and menstrual), semen, saliva, urine, sweat, and vaginal fluid.

In certain embodiments, the camera can capture multispectral images. Thus, in certain embodiments the camera is capable of multispectral imaging. In certain embodiments, the camera can provide an absorption spectrum. In certain embodiments, the camera can provide an emission spectrum.

In certain embodiments, the absorption spectrum indicates an area of interest. In certain embodiments, the absorption spectrum indicates the presence of a biofluid. In certain embodiments, the fluorescence indicates the presence of blood (peripheral and menstrual), semen, saliva, urine, sweat, and vaginal fluid.

In certain embodiments, the absorption spectrum indicates an area of interest. In certain embodiments, the absorption spectrum indicates the presence of a biofluid. In certain embodiments, the fluorescence indicates the presence of blood (peripheral and menstrual), semen, saliva, urine, sweat, and vaginal fluid. In certain embodiments, the absorption spectrum in the region of 400 nm to 450 nm is used to determine the presence of a biofluid. In certain embodiments, the absorption spectrum in the region of 400 nm to 450 nm is used to determine the presence of blood (peripheral and menstrual).

In certain embodiments, the first pump draws gas via the first end of the first transfer line to the second end of the first transfer line. In certain embodiments, the first end of the first transfer line comprises a gas inlet. In certain embodiments, the second end of the first transfer line comprises a gas outlet.

In certain embodiments, the first gas is ambient air or a non-flammable inert gas. In certain embodiments, the first gas is ambient air. In certain embodiments, the first gas is one or more selected from the list of nitrogen, argon, helium, or neon. In certain embodiments, the first gas is nitrogen. In certain embodiments, the first gas is a gas stored in a cylinder. In preferred embodiments, the first gas is ambient air from the surrounding environment.

In certain embodiments, the first transfer line comprises a filter. In certain embodiments, the filter removes particulates from the transfer line. In certain embodiments, the filter in-use removes contaminants from the transfer line (i.e. is configured to remove contaminants from the transfer line). In certain embodiments, contaminants comprise particulate material. In certain embodiments, contaminants comprise water. In certain embodiments, the filter is activated charcoal.

In certain embodiments, the temperature of the first transfer line is controlled by a heater. In certain embodiments, the heater is a coil heater. In certain embodiments, the heater is a cartridge heater. In certain embodiments, the heater is configured to operate at a fixed temperature. In certain embodiments, the heater is configured to operate at a variable temperature. In certain embodiments, the heater additionally comprises a thermocouple. In certain embodiments, the heater additionally comprises control means.

In certain embodiments, the second pump in-use draws volatile organic compounds from the first end of the second transfer line to the second end of the second transfer line. In certain embodiments, the first end of the second transfer line comprises a gas inlet. In certain embodiments, the second end of the second transfer line comprises a gas outlet.

In certain embodiments, the temperature of the second transfer line is controlled by a heater. In certain embodiments, the heater is a coil heater. In certain embodiments, the heater is a cartridge heater. In certain embodiments, the heater is configured to operate at a fixed temperature. In certain embodiments, the heater temperature is configured to operate at a variable temperature. In certain embodiments, the heater additionally comprises a thermocouple. In certain embodiments, the heater additionally comprises control means.

In certain embodiments, the heater controls the temperature of (i.e. is configured to heat) both the first transfer line and the second transfer line. In certain embodiments a first heater controls the temperature of the first transfer line. In certain embodiments a second heater controls the temperature of the second transfer line.

In certain embodiments, the first transfer line and the second transfer line are in-use heated to the same temperature, i.e. the device is configured to heat the first transfer line and the second transfer line to the same temperature. In certain embodiments, the first transfer line and the second transfer line are heated to different temperatures, i.e. the device is configured to heat the first transfer line and the second transfer line to different temperatures. In certain embodiments, the first transfer line is heated independently to the second heated transfer line, i.e. the device is configured such that the first transfer line is in-use heated independently of the second transfer line. In certain embodiments, the second transfer line is heated independently to the first heated transfer line, i.e. the device is configured such that the second transfer line is in-use heated independently of the first transfer line.

In certain embodiments, the heater has a fixed temperature (i.e. is configured to operate at a fixed temperature) between 50 and 110 Deg C. In certain embodiments, the heater has a fixed temperature (i.e. is configured to operate at a fixed temperature) between 80 and 100 Deg C. In certain embodiments, the heater has a variable temperature (i.e. is configured to operate at a variable temperature) between 50 and 110 Deg C. In certain embodiments, the heater has a variable temperature (i.e. is configured to operate at a variable temperature) between 80 and 100 Deg C.

In certain embodiments, the heater is configured such that it is only switched on when the temperature at a sample surface is below a pre-defined temperature. In certain embodiments, the heater is controllable by a computing means. In certain embodiments, the heater is configured such that it switches off in response to a sensor. In certain embodiments, the heater is configured such that it switches on in response to a sensor signal.

In preferred embodiments, the first transfer line and the second transfer line are partially or wholly housed in a probe or on the surface of a probe. In certain embodiments, the first pump, the second pump, the first transfer line and the second transfer line are partially or wholly housed in a probe or on the surface of a probe. In certain embodiments, the first pump, the second pump, the first transfer line, the second transfer line, at least one illuminating light source, the camera, heating light source and the optical transfer line are partially or wholly housed in a probe or on the surface of a probe.

In certain embodiments, the probe is suitable for being held in one hand. In certain embodiments, the probe is ergonomically designed to be held in one hand. In certain embodiments, the probe protects the user from heated components. In certain embodiments, the probe is constructed form thermally insulating materials. In certain embodiments, the first pump, the second pump, the first transfer line and the second transfer line are partially or wholly housed in a probe or on the surface of a probe wherein the probe is constructed from thermally insulating materials.

In certain embodiments, the probe further comprises a tip. In certain embodiments, the tip comprises the second end of the first transfer line and the first end of the second transfer line. In certain embodiments, the tip comprises an element which holds the second end of the first transfer line and the first end of the second transfer line in a predefined configuration. In certain embodiments, the tip comprises an element which holds the second end of the first transfer line and the first end of the second transfer line in a predefined configuration and provides a seal over a first end of the probe. In certain embodiments, the tip is plastic.

In certain embodiments, the probe comprises a handle. In certain embodiments, the probe comprises a detachable cap.

In certain embodiments, the thermally insulating material comprises a plastic.

In certain embodiments, the second transfer line is coupled to a spectrometer, i.e. the second transfer line is in fluid flow communication with a spectrometer. In certain embodiments, the second transfer line is coupled to a mass spectrometer, an ion mobility spectrometer, or a short wavelength infra-red spectrometer. In preferred embodiments, the second transfer line is coupled to an ion mobility spectrometer.

In certain embodiments, the device is suitable for the analysis of volatile organic compounds.

In preferred embodiments, the at least one illuminating light source can alternate between wavelengths. In certain embodiments, the at least one illuminating light source comprises one or more lamps. In certain embodiments, the one or more lamps emit independently any light colour selected from white light, ultraviolet light, violet light, blue light, and blue/green light. In certain embodiments, the one or more lamps emit light at one or more wavelengths selected from 400-700 nm, 350-510 nm, 350-380 nm, 410-430 nm, 420-470 nm, 445-510 nm, 480-560 nm, 570-610 nm, 600-660 nm and 800-900 nm. In certain embodiments, the one or more lamps emit light independently at a wavelength of 350-510 nm.

In preferred embodiments, the at least one illuminating light source comprises at least one lamp which emits at one or more wavelengths selected from 535 nm, 515 nm, 455 nm, 415 nm, 300-400 nm, 245 nm, 450 nm, 505 nm, 470 nm, 245 nm, 415-490 nm, 360 nm, 300-480 nm, 380-430 nm, 455 nm, 245 nm, 415-490 nm and 450 nm. In certain embodiments, the at least one illuminating light source is chosen depending on the biofluid of interest. In preferred embodiments, the at least one illuminating light source can alternate between wavelengths.

In certain embodiments, the at least one illuminating light source is a multiwavelength light source. In certain embodiments, the at least one illuminating light source is of a fixed wavelength. In certain embodiments, the at least one illuminating light source can alternate between wavelengths. In certain embodiments, the at least one illuminating light source emits light over a range of wavelengths. In certain embodiments, the at least one illuminating light source emits light in one or more of the visible region of the electromagnetic spectrum, the blue region of the electromagnetic spectrum, the ultra-violet region electromagnetic spectrum and the near infrared region of the electromagnetic spectrum.

In certain embodiments, the at least one illuminating light source comprises one or more light emitting diodes each emitting light in the visible region of the electromagnetic spectrum, the blue region of the electromagnetic spectrum, the ultra-violet region electromagnetic spectrum or the near infrared region of the electromagnetic spectrum.

In certain embodiments, the illuminating light source illuminates (i.e. causes fluorescence of) biofluids. In certain embodiments, the light source is configured to illuminate at least one of: blood (peripheral and menstrual), semen, saliva, urine, sweat, and vaginal fluid. In certain embodiments, the light source is configured to illuminate blood. In certain embodiments, the light source is configured to illuminate semen. In certain embodiments, the illuminating light wavelength is at least one of: 300-455 nm, 535 nm, 245 nm, 450 nm, 505 nm, 245 nm, 415-490 nm, 300-480 nm, 450 nm, and near-infrared.

In certain embodiments, the illuminating light source is chosen such that it induces fluorescence in biofluids.

In certain embodiments, the illuminating light source is chosen such that it induces fluorescence in one or more of blood (peripheral and menstrual), semen, saliva, urine, sweat, and vaginal fluid. In certain embodiments if a specific light source induces fluorescence in a biofluid this is indicative of the identity of the biofluid. In certain embodiments if a specific light source induces fluorescence in a biofluid the parameters for subsequent analysis can be selected. In certain embodiments if a specific light source induces fluorescence in a biofluid the parameters for ion mobility spectrometric analysis can be selected.

In certain embodiments, the fluorescence indicates an area of interest. In certain embodiments, the fluorescence indicates the presence of a biofluid. In certain embodiments, the fluorescence indicates the presence of blood (peripheral and menstrual), semen, saliva, urine, sweat, and vaginal fluid.

In certain embodiments, the device further comprises a screen. In certain embodiments, the screen displays images captured by the camera. In certain embodiments, the screen is positioned on the probe body. In certain embodiments, the screen is remote to the probe body.

In certain embodiments, the device comprises a means for controlling and/or determining the distance between the first end of the second transfer line and a sample surface. In certain embodiments, the distance may be fixed. In certain embodiments, the distance is fixed by a member (for example, an arm or a frame) extending from the device. In certain embodiments, the distance may be fixed by an O-ring. In certain embodiments, the distance may be fixed by a spacer. Thus, in-use a volume can be defined between the second end of the first transfer line, the first end of the second transfer line, the O-ring or spacer, and the sample surface. Thus, the heated gas from the second end of the first transfer line and the volatile organics from the sample surface (and their respective transfers to and from the sample surface) can be contained within the volume. In certain embodiments, the distance may be variable. In certain embodiments, the means for determining the distance may be a sensor.

In certain embodiments, the device comprises a computing means. In certain embodiments, the computing means alerts a user to a region of interest on a sample surface. In certain embodiments a region of interest is an area showing a fluorescence signal when illuminated. In certain embodiments a region of interest is an area showing signal consistent with the presence of volatile organic compounds. In certain embodiments, the computing means includes an output device. Suitable output devices include but are not limited to displays and screens, web servers, and I/O means. Examples of web servers include an Apache server, for example as part of a LAMP-Linux, Apache, MySQL, PHP stack. Other stacks include e.g. MEAN (MongoDB, Express, Angular, Node.js), LEMP (Linux, NGINX, MySQL/MariaDB, PHP/Perl/Python), LAPP (Linux, Apache, PostgreSQL, PHP), LEAP (Linux, Eucalyptus, AppScale, Python), LLMP (Linux, Lighttpd, MySQL/MariaDB, PHP/Perl/Python), and XAMPP (Cross-platform, Apache, MariaDB, PHP, Perl). Examples of I/O means include a Wi-Fi® device, cellular data device such as a mobile cellular device, and Bluetooth® device.

According to a second aspect of the invention there is provided a method of using a device of the present invention wherein the method comprises the steps of:
(a) illuminating a sample surface using the at least one illuminating light source of the device to identify an area of interest;
(b) positioning the device adjacent the sample surface at the area of interest;
(c) heating the area of interest using heated gas from the second end of the first transfer line and the heating light source to induce the release of volatile organic compounds from the area of interest on the sample surface; and
(d) drawing heated gas and volatile organic compounds into the first end of the second transfer line.

In certain embodiments where it is suspected the biofluid in the area of interest is blood, the sample surface is illuminated using near infrared light, ultraviolet light, violet light, blue light, and blue/green light. In preferred embodiments where it is suspected the biofluid in the area of interest is blood, the sample surface is illuminated using near infrared light. In certain embodiments where it is suspected the biofluid in the area of interest is blood, the sample surface is illuminated using light of one or more wavelengths selected from 535 nm, 515 nm, 455 nm, 415 nm, 300-400 nm.

In preferred embodiments where it is suspected the biofluid in the area of interest is sweat, the sample surface is illuminated using one or more of short ultraviolet light, blue light and blue/green light. In certain embodiments where it is suspected the biofluid in the area of interest is sweat, the sample surface is illuminated using light of one or more wavelengths selected from 245 nm, 450 nm and 505 nm.

In preferred embodiments where it is suspected the biofluid in the area of interest is saliva, the sample surface is illuminated using one or more of short ultraviolet light, blue light and blue/green light. In certain embodiments where it is suspected the biofluid in the area of interest is saliva, the sample surface is illuminated using light of one or more wavelengths selected from 245 nm, 470 nm and 415-490 nm.

In preferred embodiments where it is suspected the biofluid in the area of interest is semen, the sample surface is illuminated using one or more of short ultraviolet light, ultraviolet light, violet light, blue light and blue/green light. In certain embodiments where it is suspected the biofluid in the area of interest is semen, the sample surface is illuminated using light of one or more wavelengths selected from 360 nm, 300-480 nm, 380-430 nm, 455 nm, 245 nm and 415-490 nm.

In preferred embodiments where it is suspected the biofluid in the area of interest is vaginal fluid, the sample surface is illuminated using blue light. In certain embodiments where it is suspected the biofluid in the area of interest is blood, the sample surface is illuminated using light of 450 nm.

In preferred embodiments, the heating light source is chosen according to the suspected biofluid in the area of interest. In preferred embodiments where it is suspected the biofluid in the area of interest is blood, the area of interest is heated using light of a wavelength of 395-435 nm. In preferred embodiments where it is suspected the biofluid in the area of interest is blood, the area of interest is heated using light of a wavelength of 395-435 nm.

In certain embodiments, step (d) comprises transferring the heated gas and volatile organic compounds to a spectrometer. In certain embodiments, step (d) comprises drawing heated gas and volatile organic compounds into the first end of the second transfer line and transferring them to a spectrometer. Thus, the method can be a method of obtaining a spectrum of volatile organics from the sample surface.

In certain embodiments, the method is a method of determining the presence or absence of a bodily fluid selected from the group consisting of blood (peripheral and menstrual), semen, saliva, urine, sweat, and vaginal fluid, wherein the heating light source generates light at wavelengths corresponding with the absorption wavelength bands of the bodily fluid being tested for.

According to a third aspect of the invention, there is provided a method of using a device of the present invention, wherein the method comprises the steps of:
(a) illuminating a sample surface using the at least one illuminating light source of the device to identify an area of interest;
(b) positioning the tip of the device adjacent the sample surface at the area of interest; and
(c) obtaining a multispectral spectral image of the area of interest while simultaneously heating the area of interest using the heating light source to induce the release of volatile organic compounds; and/or blowing heated gas from the second end of the first transfer line at the tip of the device to the area of interest on the sample surface and drawing heated gas and volatile organic compounds into the first end of the second transfer line and transferring them to a spectrometer.

Thus, step (c) can comprise obtaining a multispectral spectral image of the area of interest while simultaneously:
(i) heating the area of interest using the heating light source to induce the release of volatile organic compounds, and/or blowing heated gas from the second end of the first transfer line at the tip of the device to the area of interest on the sample surface; and
(ii) drawing heated gas and volatile organic compounds into the first end of the second transfer line and transferring them to a spectrometer.

In certain embodiments, step (c) comprises using the heating light source to include the release of volatile organics, and blowing heated gas from the second end of the first transfer line at the tip of the device to the area of interest on the sample surface.

In certain embodiments of the methods, the first end of the second transfer line is positioned between 0.5 cm and 5 cm from the sample surface. In certain embodiments, the first end of the second transfer line is between 0.5 cm and 3 cm from the sample surface. In certain embodiments, the first end of the second transfer line is between 1 cm and 2 cm from the sample surface. In certain embodiments, the first end of the second transfer line is 1 cm from the sample surface.

In certain embodiments, the first end of the second transfer line is positioned at 25 to 90 degrees to the sample surface. In certain embodiments, the first end of the second transfer line is positioned at 50 to 90 degrees to the sample surface. In certain embodiments, the first end of the second transfer line is positioned at 80 to 90 degrees to the sample surface. In certain embodiments, the first end of the second transfer line is positioned at 90 degrees to the sample surface.

In certain embodiments, the methods above are suitable for the analysis of biofluids, drugs, explosives, nerve agents, poisons, toxins, cosmetics and food/drink. In certain embodiments, the methods above are suitable for the analysis of samples during chemical manufacture. In certain embodiments, the methods above are suitable for the analysis of human biofluids. In certain embodiments, the methods above are suitable for the analysis of human biofluids wherein the biofluids comprise one or more of blood (peripheral and menstrual), semen, saliva, urine, sweat, and vaginal fluid.

In certain embodiments, the sampling time is between 5 and 60 seconds. In certain embodiments, the sampling time is between 10 and 30 seconds. In certain embodiments, the sampling time is 20 seconds.

In certain embodiments, the steps of blowing heated gas from the second end of the first transfer line to the area of interest on the sample surface and drawing heated gas and volatile organic compounds into the first end of the second transfer line and transferring them to a spectrometer are performed simultaneously.

In certain embodiments, the steps of blowing heated gas from the second end of the first transfer line to the area of interest on the sample surface and drawing heated gas and volatile organic compounds into the first end of the second transfer line and transferring them to a spectrometer are performed sequentially.

In certain embodiments, there is a delay of 2 to 5 seconds between the steps of blowing heated gas from the second end of the first transfer line at the tip of the device to the area of interest on the sample surface and drawing heated gas and volatile organic compounds into the first end of the second transfer line and transferring them to a spectrometer are performed simultaneously. In certain embodiments, there is a delay of 2 seconds between the steps of blowing heated gas from the second end of the first transfer line at the tip of the device to the area of interest on the sample surface and drawing heated gas and volatile organic compounds into the first end of the second transfer line and transferring them to a spectrometer are performed simultaneously.

Each of the features of each of the aspects are equally applicable to any of the other aspects unless the context dictates otherwise.

### DRAWINGS

An embodiment of the invention will now be described, by way of example, with reference to the drawings, in which:

FIG. 1 is a device according to the present invention;

FIG. 2 is a device according to the present invention; and

FIG. 3 is a principal component plot showing the separation of samples analysed using a device according to the present invention.

### SPECIFIC EMBODIMENTS

A list of reference signs used is given in the section “Reference Signs” located immediately before the claims.

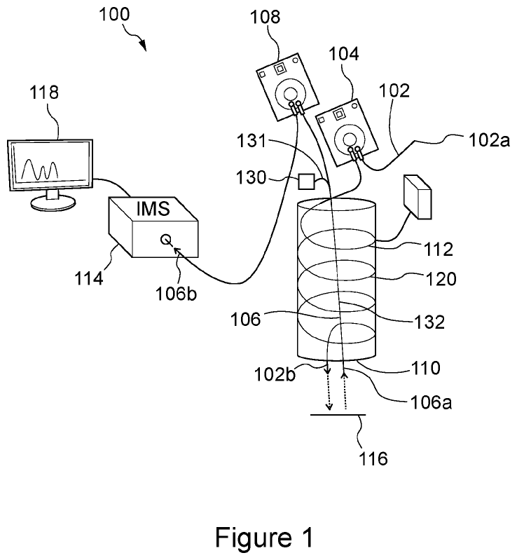

With reference to FIG. 1, a device suitable for the analysis of volatile organic compounds.

The device comprises a first transfer line (102), wherein a first disc pump (104) (TTP Ventus Limited, UK) draws a gas from the first end (102a) to the second end (102b) of the first transfer line (102), i.e. the first and second ends (102a, 102b) of the first transfer line are in fluid flow communication. The second end (102b) of the first transfer line (102) is located at the tip of the device (110) of probe (120). The first transfer line (102) comprises a heater (112), the heater increasing the temperature of the gas in the first transfer line (102). The gas exiting the second end (102b) of the first transfer line (102) at the tip (110) and heats the sample surface (116).

Heating light source (130) can be tuned to generate light at wavelengths corresponding with the absorption wavelength bands of the suspected bodily fluid (for example, blood) being tested for. Optical fibre (131) transfers light from heating light source (130) to a common transfer line portion (132) of second transfer line (106), along which it propagates to the first end (106a). The heating light then propagates to a targeted portion of sample surface (116) where it effects targeted heating and the release of volatile organic compounds from the targeted portion of sample surface (116).

A second disc pump (108) draws volatilised organic compounds from the first end (106a) to the second end (106b) of the second transfer line (106), i.e. the first and second ends (106a, 106b) of the second transfer line (106) are in fluid flow communication. The first end (106a) of the second transfer line (106) is located at the tip (110) of the probe (120). The second end (106b) of second transfer line (106) is coupled to an ion-mobility spectrometer (IMS) (114), which in turn is coupled to a computing means (118).

The first transfer line (102), the second transfer line (106) and the tip (110) are housed in probe (120).

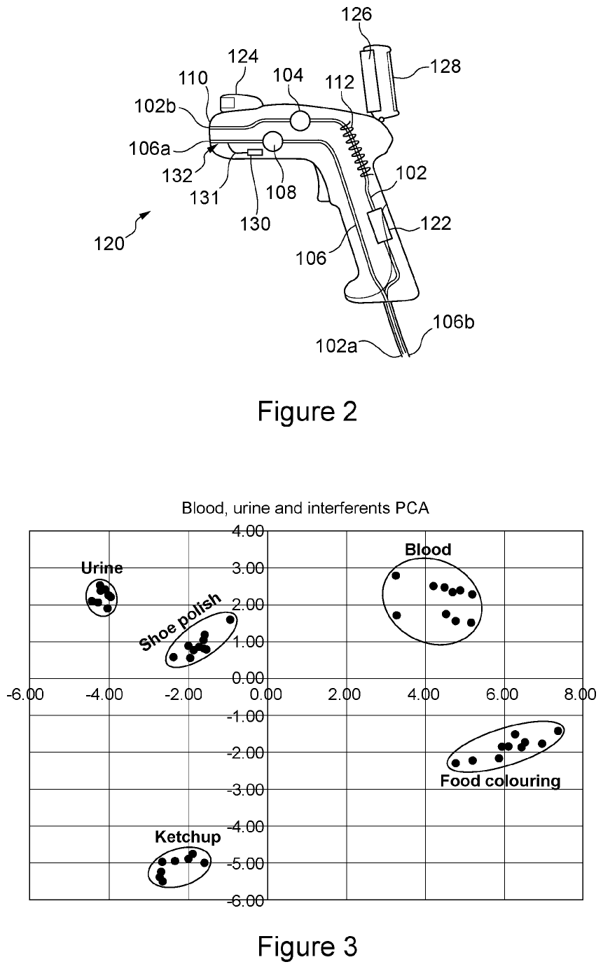

FIG. 2 illustrates a hand-held, portable probe (120) suitable for the analysis of volatile organic compounds.

The device (100) comprises a probe (120), battery, portable IMS (ion mobility spectrometer) (114) (not shown) and computing means (118). Probe (120) is hand-held. The device (100) is portable.

Probe (120) comprises an illuminating light source (124), a camera (126) and a screen (128). In-use, a sample surface (116 (not shown) is illuminated by the illuminating light source (124), and camera (126) is used to capture an image which can be viewed on the screen (128). The illuminating light source (124) emits light including near infrared (NIR). NIR reflectance is useful in locating blood spots/strains, especially on dark substrates (such as black clothing). In particular, this is useful where the dyes in the clothing become transparent in the NIR, but the blood does not.

Probe (120) further comprises a first transfer line (102), wherein a first disc pump (104) draws a gas from the first end (102a) to the second end (102b) of the first transfer line (102). The second end (102b) of the first transfer line (102) is located at the tip (110) of the probe (120). The first transfer line (102) is heated by a heater (112), thereby heating the gas as it flows through the first transfer line (102). The gas exits the second end (102b) of the first transfer line (102) and heats the sample surface (116), causing the release of volatile organic compounds from the sample surface (116).

Probe (120) further comprises a heating light source (130) which generates light at wavelengths corresponding with the absorption wavelength bands of the bodily fluid (blood) being tested for. Optical fibre (131) transfers light from heating light source (130) to a common transfer line portion (132) of second transfer line (106), along which it propagates to the first end (106a). The heating light then propagates to a targeted portion of sample surface (116) where it effects targeted heating and the release of volatile organic compounds from the targeted portion of sample surface (116).

A second disc pump (108) draws gas (including volatilised organic compounds released from the sample surface (116)) from the first end (106a) to the second end (106b) of the second transfer line (106). The first end (106a) of the second transfer line (106) is located at the tip (110) of the probe (120). The second end (106b) of second transfer line (106) is coupled to a portable ion mobility (IMS) spectrometer (114) which in turn is coupled to a computing means (118).

The first transfer line (102), the second transfer line (106) and the tip (110) are housed in a hand-held probe (120).

### EXAMPLES

Samples were prepared by adding 10 μL of each of urine, shoe polish, blood, ketchup and food colouring to small aluminium trays and drying. Each sample was presented to the device (above) for 20 seconds. Spectra were collected from ion mobility spectrometer 114 using the following parameters:
Drift Tube Temperature Set to 100 Deg C.
Sample inlet temperature set to 100 Deg C.
Flow rate set to 700 ml/min
Pressure set to 600 mBar
Acquisition time 20 seconds

Each sample was analysed ten times and the spectra for each collated and evaluated using principal component analysis. FIG. 3 shows the effective separation of samples. As can be seen from FIG. 3, the IMS allows for the positive identification of unknown samples. Effective separation of samples resulting from bodily fluids (urine and blood) and common interferents (shoe polish, food colouring, ketchup) is also shown.

Other aspects of the present invention include the following:

Aspect 1. A device suitable for the analysis of volatile organic compounds comprising:
(i) a first pump;
(ii) a second pump;
(iii) a heater;
(iv) a first transfer line wherein the first transfer line comprises a first end and a second end;
(v) a second transfer line wherein the second transfer line comprises a first end and a second end;
(vi) at least one heating light source;
(vii) an optical transfer line;
(viii) at least one illuminating light source; and
(ix) a camera;
wherein the heater is configured to transfer heat to the first transfer line;
wherein a portion of the second transfer line defines a common transfer line portion;
wherein the optical transfer line and the common transfer line portion are configured to transfer light from the heating light source to the first end of the second transfer line;
wherein the first pump is configured to in-use move a first gas via the first end of the first transfer line to the second end of the first transfer line; and
wherein the second pump is configured to in-use move a second gas via the first end of the second transfer line to the second end of the second transfer line.

Aspect 2. A device according to Aspect 1, wherein the camera is capable of multispectral imaging.

Aspect 3. A device according to Aspect 1 or 2, wherein the first gas is a non-flammable inert gas or ambient air.

Aspect 4. A device according to Aspect 3, wherein the first gas is ambient air.

Aspect 5. A device according to any preceding Aspect, wherein the first transfer line comprises a filter.

Aspect 6. A device according to any preceding Aspect, wherein the heater is coli heater or a cartridge heater.

Aspect 7. A device according to any preceding Aspect, wherein the heater is a coil heater.

Aspect 8. A device according to any preceding Aspect, wherein the heater is configured to heat the first transfer line to a temperature of between 50 and 110 Deg C., preferably between 80 and 100 Deg C.

Aspect 9. A device according to any preceding Aspect, wherein the first pump is a first disc pump.

Aspect 10. A device according to any preceding Aspect, wherein the second pump is a second disc pump.

Aspect 11. A device according to any of Aspect 2 to 10, wherein the first pump, the second pump, the first transfer line, the second transfer line, the at least one illuminating light source, the at least one heating light source and a camera are partially or wholly housed in a probe or on the surface of a probe.

Aspect 12. A device according to Aspect 11, wherein the probe comprises a handle.

Aspect 13. A device according to Aspect 11 or 12, wherein the probe is constructed of thermally insulating material.

Aspect 14. A device according to any preceding Aspect, wherein the second end of the second transfer line is coupled to a spectrometer.

Aspect 15. A device according to Aspect 14, wherein the second end of the second transfer line is coupled to a spectrometer selected from a mass spectrometer, an ion mobility spectrometer, and a short wavelength infrared spectrometer.

Aspect 16. A device according to Aspect 15, wherein the spectrometer is an ion mobility spectrometer.

Aspect 17. A device according to any preceding Aspect, wherein at least one illuminating light source is a multiwavelength light source.

Aspect 18. A device according to any preceding Aspect, wherein the device further comprises a screen.

Aspect 19. A device according to any preceding Aspect, wherein a tip comprises the second end of the first transfer line and the first end of the second transfer line.

Aspect 20. A device according to Aspect 19, wherein the tip comprises means for determining the distance between the tip and a sample surface.

Aspect 21. A method of using a device according to any preceding Aspect, wherein the method comprises the steps of:
(a) illuminating a sample surface using the at least one illuminating light source of the device to identify an area of interest;
(b) positioning the device adjacent the sample surface at the area of interest;
(c) heating the area of interest using heated gas from the second end of the first transfer line and the heating light source to induce the release of volatile organic compounds from the area of interest on the sample surface; and
(d) drawing heated gas and volatile organic compounds into the first end of the second transfer line and transferring them to a spectrometer.
Aspect 22. A method according to Aspect 21, wherein the first end of the second transfer line is positioned between 0.5 cm and 3 cm from the sample surface.

Aspect 23. A method according to Aspect 21 or 22, wherein the first end of the second transfer line is positioned 1 cm from the sample surface.

Aspect 24. A method according to any of Aspects 21-23 wherein it is a method of obtaining a spectrum of volatile organics from the sample surface.

Aspect 25. A method according to any of Aspects 21-24, wherein it is a method of determining the presence or absence of a bodily fluid selected from the group consisting of blood (peripheral and menstrual), semen, saliva, urine, sweat, and vaginal fluid, wherein the heating light source comprising wavelengths corresponding with the absorption wavelength bands of the bodily fluid being tested for.

### REFERENCE SIGNS

100—Device
102—First transfer line
102a—First end (of first transfer line 102)
102b13 Second end (of first transfer line 102)
104—First disc pump
106—Second transfer line
106a—First end (of second transfer line 106)
106b—Second end (of second transfer line 106)
108—Second disc pump
110—Tip (of probe 120)
112—Heater
114—Spectrometer
116—Sample surface
118—Computing means
120—Probe
122—Filter
124—Illuminating light source
126—Camera
128—Screen
130—Heating light source
131—Optical fibre
132—Common transfer line portion (of second transfer line 106)

1. A gas sampling device comprising:
(i) a first pump;
(ii) a second pump;
(iii) a heater;
(iv) a first transfer line wherein the first transfer line comprises a first end and a second end;
(v) a second transfer line wherein the second transfer line comprises a first end and a second end;
(vi) at least one heating light source; AND
(vii) an optical transfer line;
wherein the heater is configured to transfer heat to the first transfer line;
wherein a portion of the second transfer line defines a common transfer line portion;
wherein the optical transfer line and the common transfer line portion are configured to transfer light from the heating light source to the first end of the second transfer line;
wherein the first pump is configured to in-use move a first gas via the first end of the first transfer line to the second end of the first transfer line; and
wherein the second pump is configured to in-use move a second gas via the first end of the second transfer line to the second end of the second transfer line.

2. A device according to claim 1, wherein the first gas is a non-flammable inert gas or ambient air.

3. (canceled)

4. A device according to claim 1, wherein the first transfer line comprises a filter.

5. (canceled)

6. (canceled)

7. A device according to claim 1, wherein the heater is configured to heat the first transfer line to a temperature of between 50 and 110 Deg C., preferably between 80 and 100 Deg C.

8. (canceled)

9. (canceled)

10. A device according to claim 1, additionally comprising a camera and at least one illuminating light source.

11. A device according to claim 10, wherein the camera is capable of multispectral imaging.

12. A device according to claim 1, wherein the first transfer line and the second transfer line are partially or wholly housed in a probe or on the surface of a probe.

13. A device according to claim 10, wherein the first pump, the second pump, the first transfer line, the second transfer line, the at least one illuminating light source, the at least one heating light source and camera are partially or wholly housed in a probe or on the surface of a probe.

14. A device according to claim 12, wherein the probe comprises a handle.

15. (canceled)

16. A device according to claim 1, wherein the second end of the second transfer line is coupled to a spectrometer.

17. A device according to claim 16, wherein the second end of the second transfer line is coupled to a spectrometer selected from a mass spectrometer, an ion mobility spectrometer, and a short wavelength infrared spectrometer.

18. (canceled)

19. (canceled)

20. A device according to claim 10, wherein at least one illuminating light source is a multiwavelength light source.

21. A device according to claim 1, wherein the device further comprises a screen.

22. A device according to claim 1, wherein a tip comprises the second end of the first transfer line and the first end of the second transfer line.

23. A device according to claim 22, wherein the tip comprises means for determining the distance between the tip and a sample surface.

24. A method of using a device according to claim 10, wherein the method comprises the steps of:
(a) illuminating a sample surface using the at least one illuminating light source of the device to identify an area of interest;
(b) positioning the device adjacent the sample surface at the area of interest;
(c) heating the area of interest, using at least one of a heated gas from the second end of the first transfer line and the heating light source, to induce the release of volatile organic compounds from the area of interest on the sample surface; and
(d) drawing heated gas and volatile organic compounds into the first end of the second transfer line.

25. A method according to claim 24, wherein the first end of the second transfer line is positioned between 0.5 cm and 3 cm from the sample surface.

26. A method according to claim 24 wherein the first end of the second transfer line is positioned 1 cm from the sample surface.

27. A method according to claim 24, wherein step (d) comprises drawing heated gas and volatile organic compounds into the first end of the second transfer line and transferring them to a spectrometer, and wherein the method is a method of obtaining a spectrum of volatile organics from the sample surface.

28. (canceled)

29. A method of using a device according to claim 11, wherein the method comprises the steps of:
(a) illuminating a sample surface using the at least one illuminating light source of the device to identify an area of interest;
(b) positioning a tip of the device adjacent the sample surface at the area of interest; and
(c) obtaining a multispectral spectral image of the area of interest from the camera of the device while simultaneously heating the area of interest, using at least one of the heating light source and a heated gas, to induce the release of volatile organic compounds; and blowing heated gas from the second end of the first transfer line at the tip of the device to the area of interest on the sample surface and drawing heated gas and volatile organic compounds into the first end of the second transfer line and transferring them to a spectrometer.
